(19) United States
(12) Patent Application Publication
(10) Pub. No.: US 2014/0311663 A1
(43) Pub. Date: Oct. 23, 2014

(54) METHOD OF FABRICATING FLEXIBLE COLOR FILTER AND FLEXIBLE COLOR DISPLAY DEVICE

(71) Applicant: SUMIKA TECHNOLOGY CO., LTD., TAINAN CITY (TW)

(72) Inventors: Kung-Yi CHAO, TAOYUAN COUNTY (TW); Ying-Jie WANG, NEW TAIPEI CITY (TW); Chang-Huan WU, TAINAN CITY (TW); Kui-Fei TENG, KAOHSIUNG CITY (TW)

(73) Assignee: SUMIKA TECHNOLOGY CO., LTD., TAINAN CITY (TW)

(21) Appl. No.: 14/258,034

(22) Filed: Apr. 22, 2014

(30) Foreign Application Priority Data
Apr. 23, 2013 (TW) 102114358

(51) Int. Cl. G02B 5/23

(52) U.S. Cl. CPC G02B 5/23
USPC 156/247

(57) ABSTRACT

Methods of fabricating a flexible color filter and a flexible color display device are provided. A bonding substrate is firstly provided. The bonding substrate includes a rigid supporting substrate and a carrier-free adhesive layer, in which the carrier-free adhesive layer is disposed on the rigid supporting substrate. Next, a flexible substrate is adhered on the carrier-free adhesive layer, and a color filter layer is then formed on the flexible substrate, so as to form a color filter module. Subsequently, a cooling process is performed to separate the flexible substrate from the bonding substrate, thereby obtaining the its flexible color filter.

### RELATED APPLICATIONS

This application claims priority to Taiwan Application Serial Number 102114358, filed Apr. 23, 2013, which is herein incorporated by reference.

### BACKGROUND

1. Field of Invention

The present disclosure relates to a method of fabricating a color filter and a method of fabricating a color display device.

2. Description of Related Art

With rapid advances in science and technology, as well as modern society's thirst for information, various data acquisition and storage devices are continuously generated according to the needs. Meanwhile, specification requirements of display devices are constantly rising, in which a thin and flexible display device is a development indicator of the next generation of the display devices.

A plastic substrate may be typically used to replace a conventional glass substrate since it is thin, lightweight, flexible and unbreakable, so as to meet the development indicator of the display devices. Further, using the plastic substrate for manufacturing a flexible display device has become a main trend of research and development in that it is thin, lightweight, flexible and unbreakable.

When the plastic substrate replaces the glass substrate, conventional methods such as in-line sheet or roll-to-roll may be employed to manufacture the display devices.

However, if the method of in-line sheet is employed to fabricate a flexible color display device, the plastic substrate may be severely heat shrunken during a high temperature process and thus deformed. In addition, a stress generated by separating the plastic substrate from a bonding substrate may cause deformation of the substrate and residual adhesive and thus to reduce performance of the display device. If the method of roll-to-roll is employed to fabricate the flexible color display device, conventional production equipment cannot be used, and resolution and position accuracy of the produced display devices are poor, and a roller tension may also affect performance of the display device.

In view of the above, there is a need for methods of fabricating a flexible color filter and a flexible color display device to improve defects of the conventional methods of fabricating the flexible color filter and the flexible color display device.

### SUMMARY

Therefore, an aspect of the present disclosure provides a method of fabricating a flexible color filter, which is conducted by performing a cooling process to let an adhesive material of a carrier-free adhesive layer fail to adhere to an flexible substrate of a color filter module, and thus the flexible substrate can be separated from a bonding substrate to obtain the flexible color filter.

Another aspect of the present disclosure provides a method of fabricating a flexible color display device, which is conducted by performing the same cooling process mentioned above to let the adhesive material fail to adhere to an flexible substrate of a color display device module, and thus the flexible color display device can be obtained.

According to the above aspect of the present disclosure, a method of fabricating a flexible color filter is provided. In one embodiment, a bonding substrate is firstly provided. The bonding substrate includes a rigid supporting substrate and a carrier-free adhesive layer, in which the carrier-free adhesive layer is disposed on the rigid supporting substrate. Next, a flexible substrate is adhered on the carrier-free adhesive layer, and a color filter layer is then formed on the flexible substrate, so as to form a color filter module. Subsequently, a cooling process is performed at −20° C. to 20° C. for 3 minutes to 40 minutes to separate the flexible substrate from the bonding substrate, thereby obtaining the flexible color filter.

According to one embodiment of the present disclosure the carrier-free adhesive layer is made of an adhesive material.

According to another embodiment of the present disclosure, an adhesive strength of the adhesive material to the flexible substrate is less than 0.2 N/25 mm when a temperature of the adhesive material is lower than 20° C.

According to further embodiment of the present disclosure, the adhesive material is a crystalline polymer, which has branched acrylate.

According to further embodiment of the present disclosure, the flexible substrate is made of polyethylene terephthalate, polyimide, poly aryl ether nitrile, polystyrene, polycarbonate, stainless steel, metal complexes, glass fiber or glass.

According to another aspect of the present disclosure, a method of fabricating a flexible color display device is provided. In one embodiment, a bonding substrate is firstly provided. The bonding substrate includes a rigid supporting substrate and a carrier-free adhesive layer disposed on the rigid supporting substrate. Next, a flexible substrate is adhered on the carrier-free adhesive layer. A thin film transistor array is then formed on the flexible substrate. Subsequently, a color display layer is formed on the thin film transistor array to form a color display device module. A cooling process is then performed, which is conducted by placing the color display device module at −20° C. to 20° C. for 3 minutes to 40 minutes to separate the flexible substrate from the bonding substrate.

According to one embodiment of the present disclosure, forming the color display layer on the thin film transistor array includes forming a display medium layer on the thin film transistor array. A color filter layer is then formed on the display medium layer.

According to another embodiment of the present disclosure forming the color display layer on the thin film transistor array includes forming a color filter layer on the thin film transistor array. A display medium layer is then formed on the color filter layer.

According to further embodiment of the present disclosure, the carrier-free adhesive layer is made of an adhesive material.

According to further embodiment of the present disclosure, an adhesive strength of the adhesive material to the flexible substrate is less than 0.2 N/25 mm when a temperature of the adhesive material is lower than 20° C.

According to further embodiment of the present disclosure, the adhesive material is a crystalline polymer, which has branched acrylate.

According to further embodiment of the present disclosure, the flexible substrate is made of polyethylene terephthalate, polyimide, poly aryl ether nitrile, polystyrene, polycarbonate, stainless steel, metal complexes, glass fiber or glass.

According to further embodiment of the present disclosure, the display medium layer is made of electronic ink, liquid crystal molecules or organic light-emitting diodes.

Applying the methods of fabricating the flexible color filter and the flexible color display device of the present disclosure can obtain the flexible color filter or the flexible color display device by performing the cooling process to let the adhesive material fail to adhere to the flexible substrate, and thus the flexible substrate can be separated from the bonding substrate. Further, the bonding layer fabricated by the present disclosure can be reused.

In addition, the rigid supporting substrate used in the present disclosure is acted as the substrate of the flexible color filter or the flexible color display device, such that the flexible color filter or the flexible color display device can be applied in conventional continuous processing apparatus to decrease manufacturing cost.

### BRIEF DESCRIPTION OF THE DRAWINGS

The disclosure can be more fully understood by reading the following detailed description of the embodiment, with reference made to the accompanying drawings as follows:

FIG. 1 is a flow chart of a method of fabricating a flexible color filter according to one embodiment of the present disclosure.

FIG. 2a is a schematic structural view of a color filter module according to one embodiment of the present disclosure.

FIG. 2b is a schematic structural view of a flexible substrate according to one embodiment of the present disclosure.

FIG. 3 is a flow chart of a method of fabricating a flexible color display device according to one embodiment of the present disclosure.

FIG. 4 is a schematic structural view of a color display device module according to one embodiment of the present disclosure.

### DETAILED DESCRIPTION

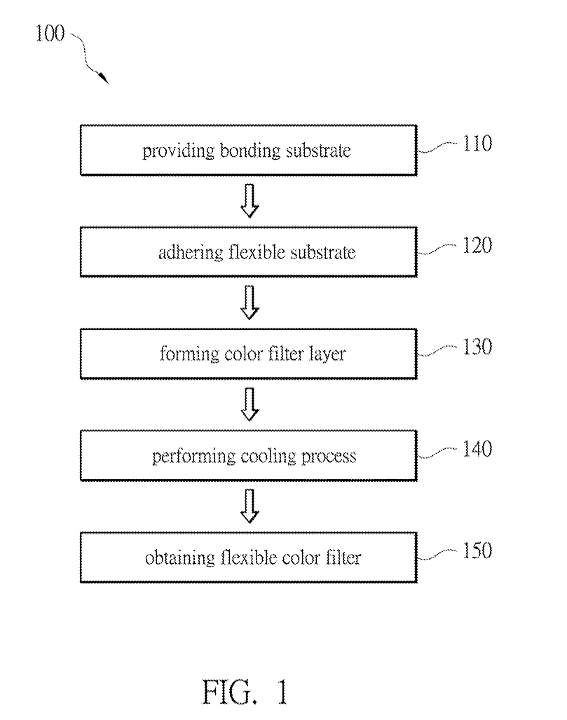

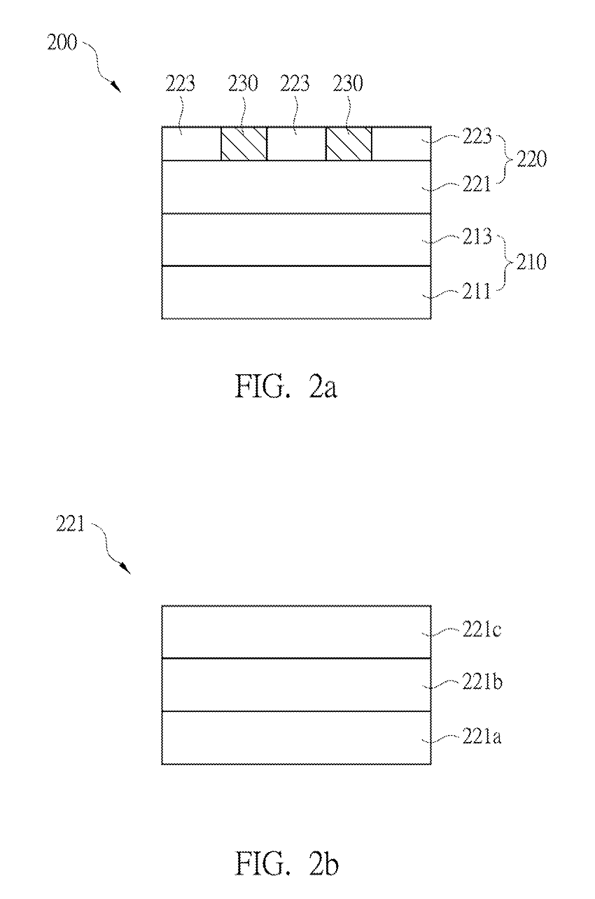

Referring to FIGS. 1 and 2a, which respectively are a flow chart of a method 100 of fabricating a flexible color filter and a schematic structural view of a color filter module 200 according to one embodiment of the present disclosure, in one embodiment, the method 100 includes a process 110 of providing a bonding substrate 210. The bonding substrate 210 includes a rigid supporting substrate 211 and a carrier-free adhesive layer 213, in which the rigid supporting substrate 211 may be an alkali-free glass substrate, a quartz substrate, a chemically strengthened glass substrate or a rigid glass substrate. The carrier-free adhesive layer 213 is disposed on the rigid supporting substrate 211 and made of an adhesive material. The adhesive material is a crystalline polymer, in which the crystalline polymer has branched acrylate. Subsequently, a process 120 is performed, which is adhering a flexible substrate 221 on the carrier-free adhesive layer 213.

Referring to FIGS. 2a and 2b, in which FIG. 2b is a schematic structural view of a flexible substrate according to one embodiment of the present disclosure, in one embodiment, the flexible substrate 221 may be a multi-layer structure including a water-gas barrier layer 221a, a substrate body 221b and a primer 221c. The substrate body 221b may be made of polyimide, poly aryl ether nitrile, polystyrene, stainless steel, metal complexes, glass fiber or glass. In one embodiment, an organic hard coat layer or another water-gas barrier layer may be interposed between the substrate body 221b and the primer 221c to increase applications of the flexible color filter. In another embodiment, anti-reflection (AR) or anti-glare (AG) treatment may be performed on an outer of the water-gas barrier layer 221a to increase performance of the flexible color filter.

Continuously referring to FIGS. 1 and 2a, a process 130 is performed after the process 120, which is forming a color filter layer 223 on the flexible substrate 221 to form a color filter module 200. The color filter layer 223 is formed on the flexible substrate 221 by a photolithography process. The color filter layer 223 may be made of a color photoresist with low cure temperature lower than 100° C. to avoid deformation of a flexible plastic substrate during a high temperature process. Further, the process temperature can be decreased by using the color photoresist with low cure temperature, such that materials having low glass transition temperature (e.g., polyethylene terephthalate, polycarbonate or other suitable materials) may be selected as a material of the flexible substrate 221 to decrease manufacturing cost.

In one embodiment the method 100 of fabricating the flexible color filter may selectively include an operation of forming a black matrix 230 before the process 130 is performed to increase contrast and performance of the flexible color filter. In another embodiment, in order to protect the color filter layer 223, the method 100 may selectively include performing an over coat process on the color filter layer 223 of the color filter module 200 to protect the color filter layer 223 and increase flatness of the color filter layer 223.

Subsequently, a process 140 is performed, which is performing a cooling process on the color filter module 200 to let the adhesive material of the carrier-free adhesive layer 213 fail to adhere to the flexible substrate 221, and thus the flexible substrate 221 can be separated from the bonding substrate 210 to obtain the flexible color filter 220. The cooling process is conducted by placing the color filter module 200 at −20° C. to 20° C. for 3 minutes to 40 minutes. In one embodiment, the cooling process may be performed using a dry freezer cabin or by placing the color filter module 200 on a freezing plate in a dry environment to decrease the temperature of the color filter module 200.

During the cooling process, when the temperature of the color filter module 200 is lower than 20° C., an adhesive strength of the adhesive material to the flexible substrate 221 (e.g., plastic substrate) is less than 0.2 N/25 mm, and an adhesive strength of the adhesive material to the rigid supporting substrate 211 (e.g., glass) of the bonding substrate 210 is greater than 5 N/25 mm under the same conditions. Accordingly, the cooling process can be used to separate the flexible substrate 221 from the bonding substrate 210. In one embodiment, when the temperature of the color filter module 200 is lower than 10° C., the flexible substrate 221 can be easily separated from the bonding substrate 210. The separated bonding substrate 210 may be heated using a hot plate or an oven to restore stickiness of the adhesive material of the carrier-free adhesive layer 213, and thus the bonding substrate 210 can be reused.

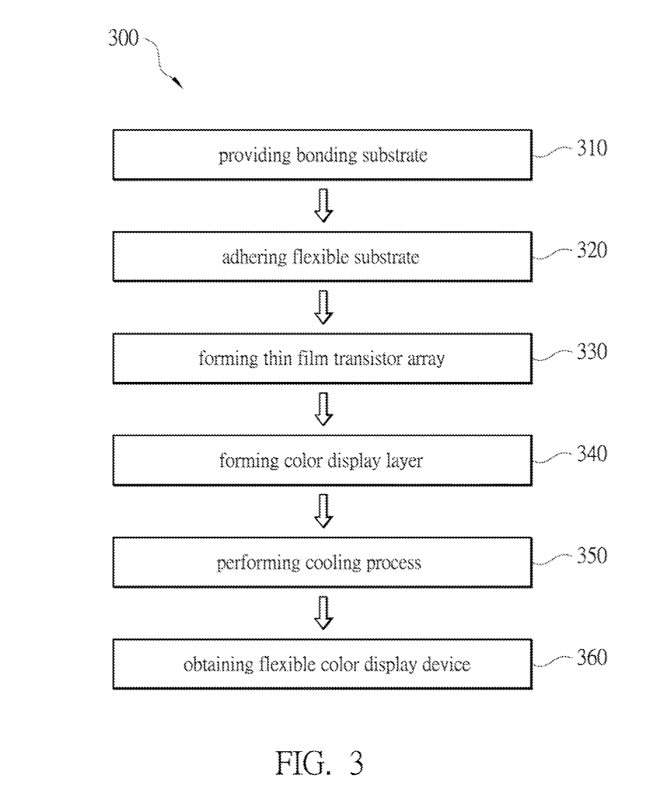

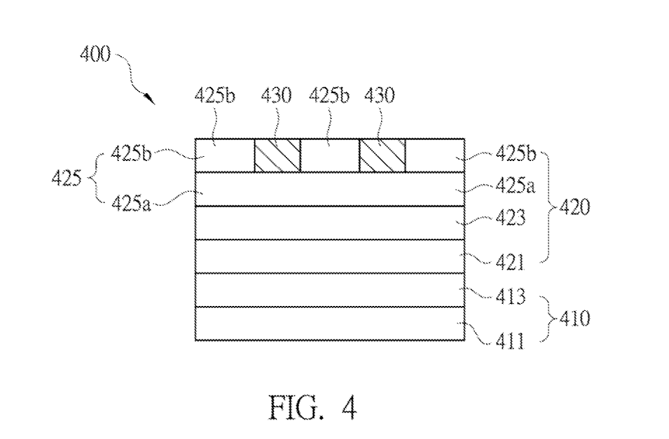

Referring to FIGS. 3-4, which respectively are a flow chart of a method of fabricating a flexible color display device and a schematic structural view of a color display device module according to one embodiment of the present disclosure, in one embodiment, the processes of the method 300 are substantially the same as those of the method 100. The difference therebetween is that in the method 300, a process 330 is performed, which is forming a thin film transistor array 423 on a flexible substrate 421 after a process 320 is performed. A process 340 is then performed, which is forming a color display layer 425 on the thin film transistor array 423 to form the color display device module 400.

The process 340 includes forming a display medium layer 425a on the thin film transistor array 423 and forming a color filter layer 425b on the display medium layer 425a. The display medium layer 425a may be made of electronic ink, liquid crystal molecules or organic light-emitting diodes.

In one embodiment, the color filter layer may be firstly formed on the thin film transistor array, and the display medium layer may then be formed on the color filter layer to form the color display device module.

Similarly, when a cooling process is performed on the color display device module 400, an adhesive strength of an adhesive material of a carrier-free adhesive layer 413 to the flexible substrate 421 is reduced, and thus the flexible substrate 421 can be separated from a bonding substrate 410, thereby obtaining the flexible color display device 420.

Before the operation of forming the color filter layer 425b on the display medium layer 425a, the method 300 may selectively include forming a black matrix 430 on the display medium layer 425a and then forming the color filter layer 425b on the display medium layer 425a to increase contrast and performance of the flexible color display device 420.

From the above embodiments of the present disclosure, the methods of fabricating the flexible color filter and the flexible color display device may obtain the flexible color filter and the flexible color display device by performing the cooling process to decrease the temperature of the flexible color filter module or the flexible color display device module, which results in decreasing of the adhesive strength of the carrier-free adhesive layer of the bonding substrate to the flexible substrate, but the adhesive strength thereof to the rigid supporting substrate is not affected, and thus the flexible substrate can be separated from the bonding substrate.

Furthermore, when the temperature of the bonding substrate is higher than 20° C., the carrier-free adhesive layer of the bonding substrate may restore stickiness, and thus the bonding substrate can be reused to decease manufacturing cost.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method of fabricating a flexible color filter, the method comprising:
providing a bonding substrate, comprising:
a rigid supporting substrate; and
a carrier-free adhesive layer, disposed on the rigid supporting substrate;
adhering a flexible substrate on the carrier-free adhesive layer;
forming a color filter layer on the flexible substrate to form a color filter module; and
performing a cooling process, which is conducted by placing the color filter module at −20° C. to 20° C. for 3 minutes to 40 minutes to separate the flexible substrate from the bonding substrate, thereby obtaining the flexible color filter.

2. The method of claim 1, wherein the carrier-free adhesive layer is made of an adhesive material, and an adhesive strength of the adhesive material to the flexible substrate is less than 0.2 N/25 mm when a temperature of the adhesive material is lower than 20° C.

3. The method of claim 2, wherein the adhesive material is a crystalline polymer, which has branched acrylate.

4. The method of claim 1, wherein the flexible substrate is made of polyethylene terephthalate, polyimide, poly aryl ether nitrile, polystyrene, polycarbonate, stainless steel, metal complexes, glass fiber or glass.

5. A method of fabricating a flexible color display device, the method comprising:
providing a bonding substrate, comprising:
a rigid supporting substrate; and
a carrier-free adhesive layer, disposed on the rigid supporting substrate;
adhering a flexible substrate on the carrier-free adhesive layer;
forming a thin film transistor array on the flexible substrate;
forming a color display layer on the thin film transistor array to form a color display device module; and
performing a cooling process, which is conducted by placing the color display device module at −20° C. to 20° C. for 3 minutes to 40 minutes to separate the flexible substrate from the bonding substrate, thereby obtaining the flexible color display device.

6. The method of claim 5, wherein forming the color display layer on the thin film transistor array comprises:
forming a display medium layer on the thin film transistor array; and
forming a color filter layer on the display medium layer.

7. The method of claim 5, wherein forming the color display layer on the thin film transistor array comprises:
forming a color filter layer on the thin film transistor array; and
forming a display medium layer on the color filter layer.

8. The method of claim 5, wherein the carrier-free adhesive layer is made of an adhesive material, and an adhesive strength of the adhesive material to the flexible substrate is less than 0.2 N/25 mm when a temperature of the adhesive material is lower than 20° C.

9. The method of claim 8, wherein the adhesive material is a crystalline polymer, which has branched acrylate.

10. The method of claim 5, wherein the flexible substrate is made of polyethylene terephthalate, polyimide, poly aryl ether nitrile, polystyrene, polycarbonate, stainless steel, metal complexes, glass fiber or glass.

11. The method of claim 6, wherein the display medium layer is made of electronic ink, liquid crystal molecules or organic light-emitting diodes.

12. The method of claim 7, wherein the display medium layer is made of electronic ink, liquid crystal molecules or organic light-emitting diodes.
